(19) United States
(12) Patent Application Publication
(10) Pub. No.: US 2005/0111363 A1
(43) Pub. Date: May 26, 2005

(54) Operating system for telecommunications

(76) Inventors: William Martin Snelgrove, Toronto (CA); Michael Stumm, Toronto (CA); Mauricio De Simone, Toronto (CA)

Correspondence Address: KATTEN MUCHIN ZAVIS ROSENMAN, 525 WEST MONROE STREET, CHICAGO, IL, 60661-3693, US

(21) Appl. No.: 10/971,139

(22) Filed: Oct. 25, 2004

(30) Foreign Application Priority Data
Sep. 24, 1999 (WO) PCT/CA99/00874
Mar. 4, 1999 (CA) 2,264,407

(51) Int. Cl. H04L 12/26

(52) U.S. Cl. 370/230

(57) ABSTRACT

The present invention relates generally to telecommunications, and more specifically, to an improved operating system and apparatus for telecommunications networks. Currently, the majority of telecommunication services are provided over the Public Switched Telephone Network and Internet. Existing telephony systems suffer from a number of problems including system complexity, limited access and implementation of services on fixed hardware, which results in long time to bring new products to market. Internet applications cannot guarantee quality of service in the transmission. These systems are therefore inflexible and inefficient which limits their ability to carry new services. The invention provides a distributed and real-time operating system for use over varied telecommunications networks. As well, methods of implementing synchronized execution, fault tolerance and loading management over this network, are also described. The application of this operating system to existing networks allows new services to be provided.

### FIELD OF THE INVENTION

The present invention relates generally to telecommunications, and more specifically, to an operating system and apparatus for telecommunications networks.

### BACKGROUND OF THE INVENTION

Telecommunications systems, such as those for telephony and the Internet, are composed of terminal equipment such as telephones or personal computers; an access network such as a telephony local loop or a radio link, and switches or routers; and a backbone network such as the public switched telephone network (PSTN) or the intercity data networks. One design challenge is that the needs of users at the terminals are very varied, but the backbone networks must handle highly standardized loads in order to operate reliably and efficiently.

Telecommunications systems need to process the data flowing through them in complex ways, often with processing occurring on computer systems separated both geographically and administratively. Many communications paths are simultaneously active, and the processing applied to the various flows of data changes frequently and in a wide variety of ways. The software needed to control these computer systems is generally large, complex and difficult to change.

When the data flowing through the system represents voice, such as in a modern digital telephone network, special processing must be applied to implement such features as three-way or multi-way calling, voice-mail, voice-recognition and authentication, call waiting, encryption, voice coding and dual-tone multi-frequency (DTMF) detection. For data applications in general, such as electronic mail, remote computing, file transfer between computers or Web browsing, there are needs for security functions such as firewalls and encryption as well as datastream functions such as traffic shaping, error handling, prioritization, caching, format translation and multicast.

While telecom systems are already complex, there is a market for new services such as video telephony, Internet games, video on demand, Internet audio, remote collaborative work and telemedicine. These services will need new families of features to be overlaid on the existing network, making the software development task even more complex.

As well, even for a single application, different users may have different needs, for example, requiring different degrees or forms of encryption. This makes the development of communications applications slow due to the complexity of handling many cases.

FIG. 1 presents a typical implementation of a telephony system 10. This telephony system 10 includes switches 12 controlled by large computer programs in switch controllers 14. Switches 12 are interconnected with one another by trunks 16 which carry the actual communication signals and may consist of a variety of physical media, such as optical fibre and coaxial cables. Switch controllers 14 are also interconnected, generally by means of signalling lines 18 rather than over the communication trunks 16.

These systems 10 also include computing means to implement such features as conference calling 20, voice mail 22 and toll services 24. Telephony features, such as call forwarding, may be implemented by adding code to the programs running the switches 12 or by adding specialized hardware to the telephony network 10. The features available to particular users are defined in databases accessed by the switch 12 software, and adding a new type of feature may involve changing these databases together with all of the switch 12 software that uses them, and may also involve purchasing and installing new types of hardware in the network. Specialized software is also used to check the consistency of the features assigned to a particular user. For example, call-waiting and call-forward-on-busy features define different behaviours for the same event, a busy receiver; so both features may not be assigned to a user simultaneously.

The access network for telephones 26 in a classical telephony system consists of little more than the “local loop” wiring 28 between terminals owned by customers and the switching network operated by a telephone company. Advanced functionality is all concentrated in the switches 12.

In general, signal processing for telephony is done in hardware specialized for each type of task, for example, there is different hardware for tone decoding and conferencing. This limits the speed with which new features can be introduced since new hardware has to be designed, tested, manufactured and deployed. The fixed assignment of tasks also makes it impossible to share loads between different types of hardware, for example to use idle tone-decoding hardware to help with an overload of voice-conferencing.

The switching software implements feature such as conference calling by arranging for telephone switches 12 to direct streams of data representing user voices to and from hardware or software 20 specialized to do the computations necessary to add these voice streams together in a way that emphasizes active speakers and suppresses background noise. When a user expresses a wish to enter a conference call, either by making appropriate entries via the keypad of a telephone 26 or by communicating with an operator, the operating system of the switch 12 searches for and then allocates an unused set of inputs and outputs on conferencing hardware 20. If the switch 12 succeeds, it then searches for and allocates paths to and from those inputs and outputs, respectively from and to the telephone sets 26 of the participants in the call, on such channels as multiplexed buses and synchronous optical networks. The manner in which this software searches for and allocates these resources is entirely under the control of software written by the manufacturer of the switch 12 and is controlled by the owner of the switch 12, so that a third party cannot make improvements. These telephony features are in fact little used by members of the public, because the user interface is difficult to understand.

Changes to existing telecommunication networks 10 are therefore very complicated to make. There is a rigid model and hardware structure is difficult to extend. Therefore, existing telcos can not offer new features such as high quality voice. As well, existing telco's take a long time to bring such features to market.

The complexity of present telecommunications systems software, and the extensive interactions between its software components, makes the development of new features very difficult. As well, telecomm services have traditionally been provided by large monopolies who employed proprietary equipment that only they had access to. Another complexity is that new services had to be backward compatible to handle their existing clientel.

Software development is therefore limited to a “closed” group of trusted developers, which reduces the talent pool available and shuts out developers with new ideas for niche markets.

Traditional telecomm does not consider differentiation, but focuses on provision of single services. Therefore, telecomm providers would not be encouraged to offer varied services at a cost reduction to users, for example, reduced quality of voice telephony on Christmas Day, simply to provide additional connections or reduced cost. As well, small niche markets have gone unserved completely as the cost of developing and implementing the additional products does not net sufficient profits.

Users can exercise a small degree of control over their telecommunications by use of software running on their personal computers (PCs). For example, there is currently a Telephony Applications Programming Interface (TAPI) that allows software running on a general-purpose computer to control the switching decisions of a type of switch known as a private branch exchange (PBX).

An application programming interface (API) converts a series of comparatively simple and high level functions into the lower level instructions necessary to execute those functions, simplifying use of an operating system. Using Windows APIs, for example, a program can open windows, files and message boxes, as well as perform more complicated tasks, by executing single instructions. Windows has several classes of APIs that deal with telephony, messaging, and other communication issues.

These APIs can be implemented in Java, which is a popular computer language enhanced by features that facilitate loading programs across the Internet and which can enforce strict rules that ensure that such programs do not contain software viruses that could interfere with the operation of the system to which they are downloaded. Java is also widely used for programming advanced graphical user interfaces (GUIs) such as those used on some Web pages, so that one skilled in the art can readily write a GUI that controls a telephony switch. A system known as JTAPI is an example of a Java Telephony API.

The TAPI consists of a large collection of specialized subroutine calls that allow a user to set up and tear down circuits connecting particular physical devices, including telephone sets and servers for functions such as voice-mail. It also allows the user to define how the system should respond to events such as hangups.

A system known as Parlay implements a telephony API that can be used to control the central office telephone switches owned by large telephone companies. This is similar in concept to the use of a telephony API to control a PBX, but security concerns are of prime concern because of the number of telephone users who would be inconvenienced by a failure.

Parlay, TAPI, J-TAPI and similar systems permit third parties a degree of control over how telephone switches interconnect end users and specialized equipment such as voice-conferencing servers, but do not allow third parties to add new features such as encryption or voice coding. They are also unable to describe the handling of Internet traffic, and so it is necessary for a distinct system to be used to handle such functions as routing Internet browsing data through computers acting as security firewalls.

In a cellular telephone system or personal communications system (PCS), the mobile telephones contain embedded computers that process the radio and voice signals and that implement control protocols to communicate with basestations. The basestations also contain embedded computers for these purposes, so that the collection of mobile telephones and base stations forms a network that allows the mobile telephones access to the public switched telephone network (PSTN) or other access networks.

This access network for cellular telephony is much more sophisticated than that for classical telephony, in that it performs advanced signal processing functions such as data compression for voice and advanced call processing functions such as support for handoff of telephone conversations from one base station to another during a call. A key difficulty is that the functions that the embedded computers in the mobile telephone can perform are fixed in advance, programmed into them with read-only memories and limited by the capabilities of the standard protocol used to communicate with the basestations. The voice compression algorithms used to reduce data traffic, for example, are fixed in advance and cannot be easily changed when a new algorithm is developed.

Networks for telephony and data transmission have developed separately, but the economic rationale for having distinct physical networks is very weak and therefore the technologies are converging. They appear to be converging on a model closer to that for data than that for telephony, partly because of its greater generality. The dominant data network is currently the Internet.

FIG. 2 presents a layout of an exemplary Internet communications system 30. The Internet 32 itself is represented by a number of routers 34 interconnected by an internet backbone 36 network designed for high-speed transport of large amounts of data. Users computers 38 may access the Internet in a number of manners including modulating and demodulating data over a telephone line using audio frequencies which requires a modem 40 and connection to the Public Switched Telephone Network 42, which in turn connects to the Internet 32 via a point of presence 44 and access controller 46. Another manner of connection is the use of set top boxes 50 which modulate and demodulate data onto high frequencies which pass over existing telephone or television cable networks 52 and are connected directly to the Internet via controller 54. Generally, these high frequency signals are transmitted outside the frequencies of existing services passing over these telephone or television cable networks 52.

Part of the access network in these systems is usually a set of computer systems 38 at the edge of the backbone network 36 which perform functions such as authentication of users and control of the load that they place on the backbone network 36. Communications between users' computers 36 and the rest of the network 36 are standardized by means of defined communications protocols.

Communications over the Internet can take the form of various protocols, over a variety of physical transfer media. A protocol is a set of conventions or rules that govern transfer of data between hardware devices. The simplest protocols define only a hardware configuration while more complex protocols define timing, data formats, error detection and correction techniques and software structures.

The Internet is a connectionless network service, in that a single communication may be broken up into a multitude of data packets that follow different paths in flowing between the same source and destination. Traditional telephony in contrast, establishes a single path that all of the data in the communication follow.

Socket mechanisms are widely used to describe connections between applications programs running on operating systems such as UNIX and Windows. They can be used to set up connections between applications programs running on different computers, such that packets of data are passed between them across such networks as an Ethernet or the Internet. In Java, for example, the expression ‘new Socket(“www.wireless-sys.com”, 8888)’ returns an object that represents a connection to “port 8888” on a computer on the Internet whose name is “www.wireless-sys.com”. This object can be used with other Java methods to send data to, and receive data from, this computer. The “port number” is used by convention to define the type of data expected.

When using a socket to communicate with a process on another computer, the programmer defines one side of a communication but must rely on the administrators of the other computer to have set up the other side. The port number is used by convention to describe the functionality of the program expected.

Sockets typically use the Internet Protocol (IP) and can further be set up to use either the Unreliable Datagram Protocol (UDP) which sends packets without checking to see if they have been received, or the Transport Control Protocol (TCP) which will retry until it receives a confirmation of receipt. Telephony applications typically use UDP, because data that does not arrive on time is of no value, while file transfer programs typically use TCP so that accurate delivery is assured. The user is generally required to choose between these two mechanisms to specify handling of error conditions in packet delivery or to write a new mechanism ab initio. Just as for telephony, it is difficult to add encryption or signal processing features to the handling of an IP stream.

The key advantages of a protocol like IP are that it allows a large network to function efficiently and that it offers a standardized means by which applications software can use that network. Disadvantages are that it does not allow specification of processing to be performed on data streams and that it does not accurately specify requirements on quality of service.

The resource reservation protocol (RSVP) is an extension to IP that permits specification of quality of service at a technical level, in terms of parameters such as data rates and latencies. It has had limited acceptance due to the complexity it adds to backbone networks and the need for their switching hardware to be updated, and it fails to include mechanisms to specify the costs associated with the QoS demands that it makes.

Asynchronous Transfer Mode (ATM) networks use standard protocols for addressing packets of data (as does IP), setting up connections (as does TCP), and specifying QoS (as does RSVP). ATM networks have typically been deployed in the core of backbone networks because of the high speeds at which ATM equipment operates, but their capabilities have not been directly visible to end users (because of the dominance of IP as an applications standard and the high costs of ATM equipment). Because ATM routers are not directly accessible and because of the complexity of their mechanisms for describing QoS, these mechanisms have not been used by applications software. Also, these QoS mechanisms, like RSVP, do not include methods by which to describe the costs associated with a QoS demand.

Besides the IP and ATM networks mentioned above, there are other networks such as Frame Relay and Ethernet. As well the PSTN may also be used to carry data, for example using trellis coding which maps digital data onto an analogue signal. Variants are also evolving of each major type of network, and engineering differences between implementations of these networks result in different performance. The complexity induced by this variety makes it difficult for users and application software to exploit all the networks available, and to exploit any to its fullest.

The access networks known in the art have severe limitations that come from their having been designed for overly narrowly defined telecommunications applications, such as telephony or file transfer. Therefore, an invention which allows an access network to have the sophisticated functionality necessary for a mixture of telecommunications services is required.

There is therefore a need for a method and system of providing telecommunication services that are flexible and efficient, and improve upon the problems described above. This design must be provided with consideration for ease of implementation and recognize the pervasiveness of existing infrastructure.

### SUMMARY OF THE INVENTION

It is therefore an object of the invention to provide an operating system and apparatus for telecommunications networks which improves upon the problems outlined above.

One aspect of the invention is broadly defined as a method of implementing a communication over a telecommunications network comprising the steps of: defining the communication as a stream of data; and transporting the stream of data over the telecommunications network by identifying and executing operating system software functions in real-time, where the operating system software functions are distributed over the telecommunications network.

Another aspect of the invention is defined as a telecommunications system comprising: a calling party; a called party; a mixed-protocol telecommunications network interconnecting the calling-party and the called party; the calling party being operable to: define the communication as a stream of data; and the telecommunications network being operable to: transport the stream of data to the called party by identifying and executing operating system software functions in real-time, where the operating system software functions are distributed over the telecommunications network.

Another aspect of the invention includes a computer readable memory medium, storing computer software code executable to perform the steps of: defining the communication as a stream of data; and transporting the stream of data over the telecommunications network by identifying and executing operating system software functions in real-time, where the operating system software functions are distributed over the telecommunications network.

Another aspect of the invention includes a computer data signal embodied in a carrier wave, the computer data signal comprising a set of machine executable code being executable by a computer to perform the steps of: defining the communication as a stream of data; and transporting the stream of data over the telecommunications network by identifying and executing operating system software functions in real-time, where the operating system software functions are distributed over the telecommunications network.

A further aspect of the invention include a cellular telephone comprising: central processor means; wireless communication input and output means connected to the central processor means; memory storage means connected to the central processor for storing software code downloded via the wireless communication input and output means, the software code being executable on the central processor; real-time distributed operating system kernel software code executable on the central processor; and user interface means interconnected with the central processor.

The invention provides for a distributed operating system with real-time characteristics and advanced security and accounting and management features to be provided with an API suitable for development of a wide variety of services. It provides for this software to run on hardware specialized for connection to such devices as telephones and personal computers, which may be found in homes and offices, and also on hardware suitable for connection to backbone networks. It also provides for physical means of communications between these types of hardware, and therefore constitutes an access network

### BRIEF DESCRIPTION OF THE DRAWINGS

These and other features of the invention will become more apparent from the following description in which reference is made to the appended drawings in which:

FIG. 1 presents a physical layout of an exemplary telephony network known in the art;

FIG. 2 presents a physical layout of an exemplary Internet network known in the art;

FIG. 3 presents a flow chart of a method for implementing a communications system in a broad manner of the invention;

FIG. 4 presents a physical schematic of a communications system in a broad manner of the invention;

FIGS. 5A and 5B present a flow chart of a method for implementing a communications system in a preferred embodiment of the invention;

FIG. 6 presents a physical schematic of a communications system in a preferred embodiment of the invention; and

FIG. 7 presents an electrical block diagram of a cellular telephone in a manner of the invention.

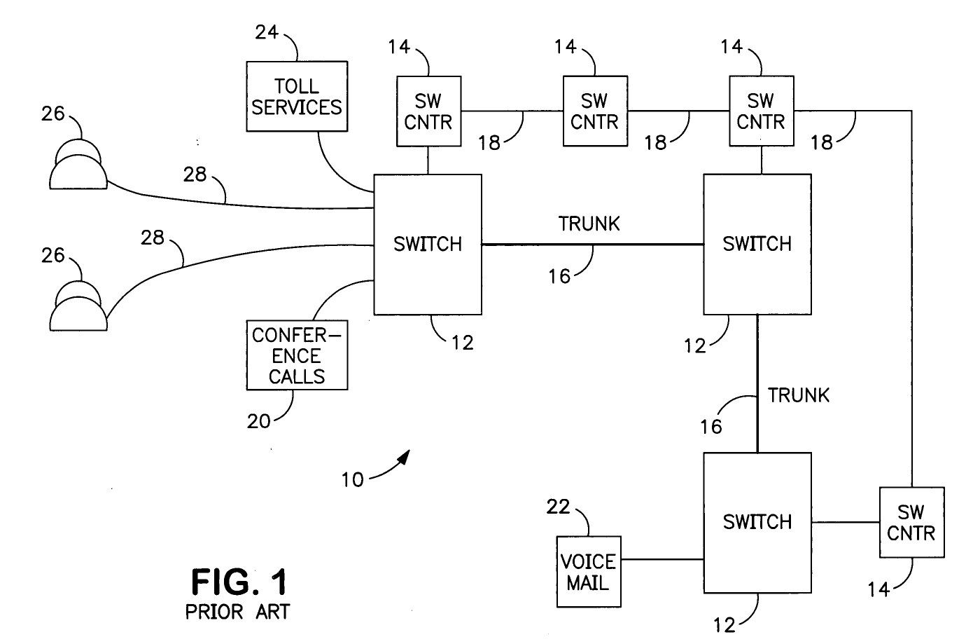

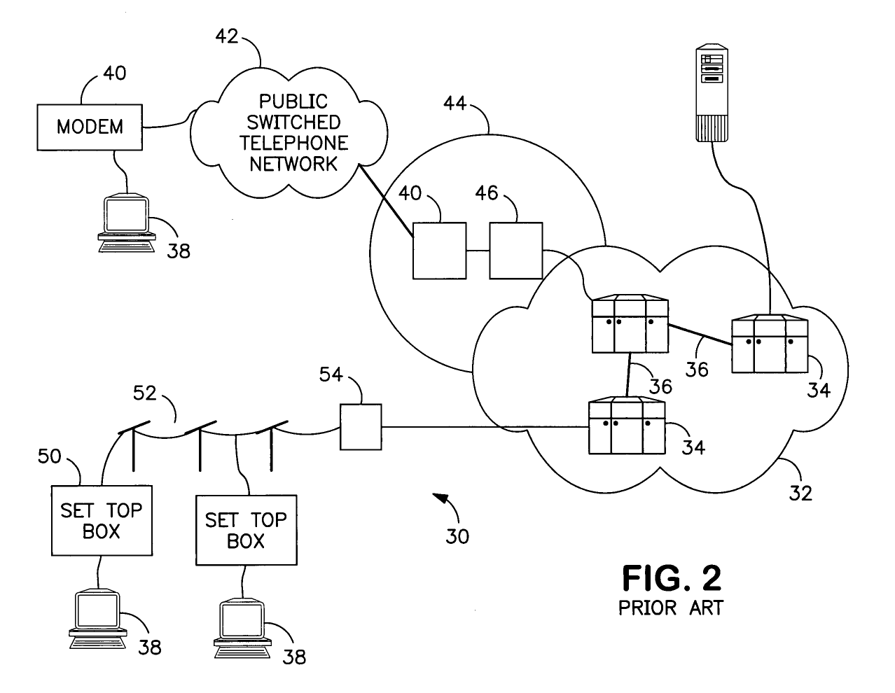

### BRIEF DESCRIPTION OF THE BROAD INVENTION

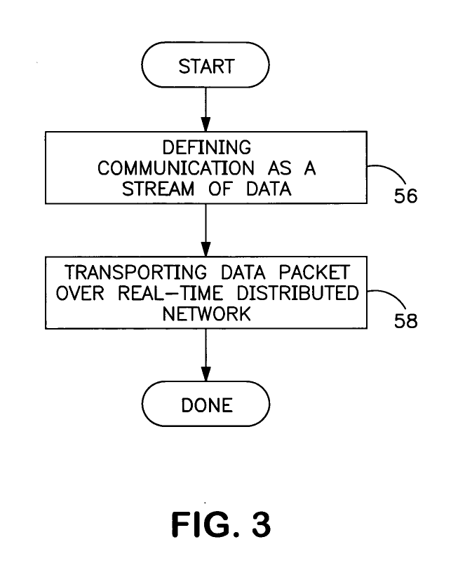

A method of implementing a communication over a telecommunications network which addresses the objects outlined above, is presented as a flow chart in FIG. 3. Using this method the communication is defined in terms of a stream of data at step 56, which could be delivered as a series of packets in the manner of TCP/IP. This data stream is then transported over the telecommunications network by identifying and executing operating system software functions in real-time at step 58, where the operating system software functions are distributed over the telecommunications network.

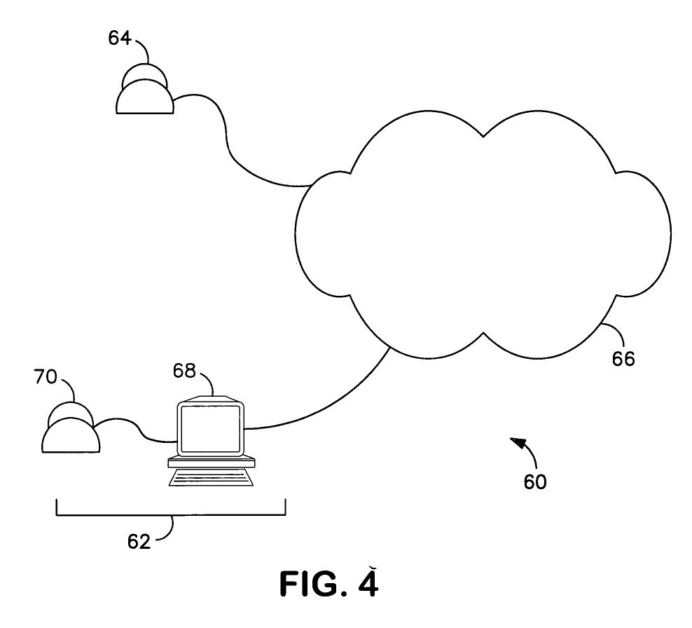

A physical representation of this system is presented in FIG. 4. This figure presents a telecommunications system 60 which allows a calling party 62 to communicate with a called party 64 over a mixed-protocol telecommunications network 66 which physically interconnects the two parties. As an example, the calling party 62 is shown to include a general purpose computer 68 with an audio interface, which may be a standard telephone 70, which the computer 68 is connected to via a telephony card. The signal processing functions necessary for telephony are implemented with a specialized computer on the telephony card, while the control functions are implemented on the computer 68 itself. This allows for sophisticated access control, since the computer 68 can be seen as part of the access network.

In this figure, the called party 64 is shown to be a telephone, but of course it could be any telephony device such as a fax machine or modem. Other suitable devices and arrangements would be clear to one skilled in the art.

The invention is realized by the calling party 62 having the functionality to define a communication as a stream of data or data packets, and the telecommunications network 66 being operable to transport the stream of data over the network 66 by identifying and executing operating system software functions in real-time, where the operating system software functions are distributed over the telecommunications network 66.

An operating system is generally a set of software that interfaces the hardware with the user or application programs, schedules tasks, allocates storage and interfaces control of the hardware. The facilities an operating system provides and its general design philosophy exert an extremely strong influence on programming style and on the technical cultures that grow up around its host machines.

Real-time operating systems are operating systems where certain functions are required to be executed within certain time limits, giving the user the perception of continuous operation. In voice communication for example, users will not generally acceptable total unidirectional time delays, referred to as latencies, of greater than 200 milliseconds. Therefore, total execution time of all functions that affect the voice signal will have to be executed in less than 200 milliseconds.

Real-time operating systems generally break software code up into multiple executable units called threads, which are scheduled for execution within their corresponding time limits. Execution of threads is done by priority, for example, a thread handling a live voice transmission will generally have higher priority than a data transmission.

Such techniques are known in the art of computer software and in embedded systems in particular, but have not been applied to telephony networks for several reasons.

Firstly, the dominant telecomm providers have been slow to stray from their vast PSTN infrastructures which were not thought suitable for open systems. Because outside users are not able to access and modify the PSTN, they are limited to the functionality that the PSTN system provides. However, as the existing PSTN is in fact a real-time system, the invention does not alter the PSTN itself, but sends it a stream of data encapsulated as PSTN packets which can traverse the PSTN network. Access to the PSTN is controlled by means of proxies, and enabling by use of gateways.

Existing telecomm providers seek to continue use of their intelligent network (IN) and advanced Intelligent network (AIN) services because of their enormous investments in the hardware and software to provide these services. The invention does not have to address integration with these systems because it is far easier to simply create new software to provide the same services. However, it is preferred that the operating system of the invention include SS7 stacks that allow user processes to control it and interact with it.

Secondly, it is difficult to implement real-time systems over mixed protocol networks without incurring quality problems. This was thought to be a hindrance to the integration of PSTN and data networks. Those quality problems and their solutions will be described in greater detail with respect to the preferred embodiment.

Distributed operating systems are computer programs that coordinate the operation of a collection of computers so that tasks may be run interchangeably on any of them, giving the whole collection of computers the appearance of a single unified system to applications programs and to end users. They allow end users at terminal equipment or who are directly using the computers running the distributed operating system, access to all of the resources of the system.

Implementing a distributed operating system over a variety of networks with different protocols requires gateways to interface the various networks. These gateways must recognize and compensate for needs of related networks.

In the invention, the network is both real-time and distributed. Therefore, time limits must be included in the executable threads when they are distributed.

The application of a real-time distributed operating system to a mixed-protocol telecommunication network in a manner of the invention offers a number of advantages over the prior art.

The real-time functionality allows the use of audio, video and voice signals to be transported with sufficient speed to be comfortable to users. Many existing telecommunications systems, particularly those employing the Internet as a communications medium, suffer from serious quality problems including chatter and lost packets. The invention provides a means for maintaining quality of service in transmission over such networks, This will be described in greater detail hereinafter.

The distributed nature of the invention offers a number of operational advantages including:
1. Greater reliability as faults are more likely to occur at distributed functions rather than at the kernel. This way, the kernel does not fail if there is a software problem and the system may continue to operate.
2. Flexibility in that devices may be upgraded functionality, or new features accessed without having to reboot.
3. Redundancy is provided at the software level, rather than the hardware level as the PSTN had used in the past. The reduction in hardware by a matter of 50% reduces capital, operating and maintenance costs, building services and support staff, all without comprising efficiency and reliability. In fact, reliability can easily be increased by orders of magnitude be adding an additional layer of software redundancy.
4. The scalability of this system also allows for an incremental implementation, adding new gateways as new network are added. As new networks evolve which replace the existing PSTN, Internet, ATM and similar networks, new gateways can be added to leverage off the existing infrastructure.
5. This system does not have a single point of failure, as communications can be re-routed in the event of a node or line failing.

As well, the system of the invention offers a simplified physical installation as only a single physical network is required to transport multiple services such as a combination of voice telephone via PSTN or PBX, or data, via Internet, local area network (LAN) or other network. This results in a reduction of installation materials and labour, and reduction in maintenance of the necessary wiring and routing hardware. For example, a typical business office may have had separate PBX and LAN networks in the past, but the invention provides both services over a single physical network.

It is preferred that this system be “active” in the sense of allowing signal processing functions such as voice conferencing or IP filtering to be inserted. It should use general-purpose hardware to the greatest extent possible to gain the economies of scope that come when a single piece of hardware can serve many purposes.

This system should include very general mechanisms for the specification of QoS parameters such as bandwidth and latency, and a means of negotiating for them.

Because an access network generally connects two domains administered by different parties (such as an end user and a service provider), it should include trustworthy mechanisms for both to operate it; this might include such things as software proxies responding to the needs and interests of the different parties and libraries of filters with known characteristics.

This network should also ideally allow new parties to contribute to its functionality, such as by administering technically difficult systems in the interests and at the behest of end users.

Description of the Preferred Embodiments of the Invention

The real-time distributed operating system of the invention preferably has a number of other major features including data packet synchronization, load management and fault resistance. These features will now be described by means of reference to the preferred embodiment.

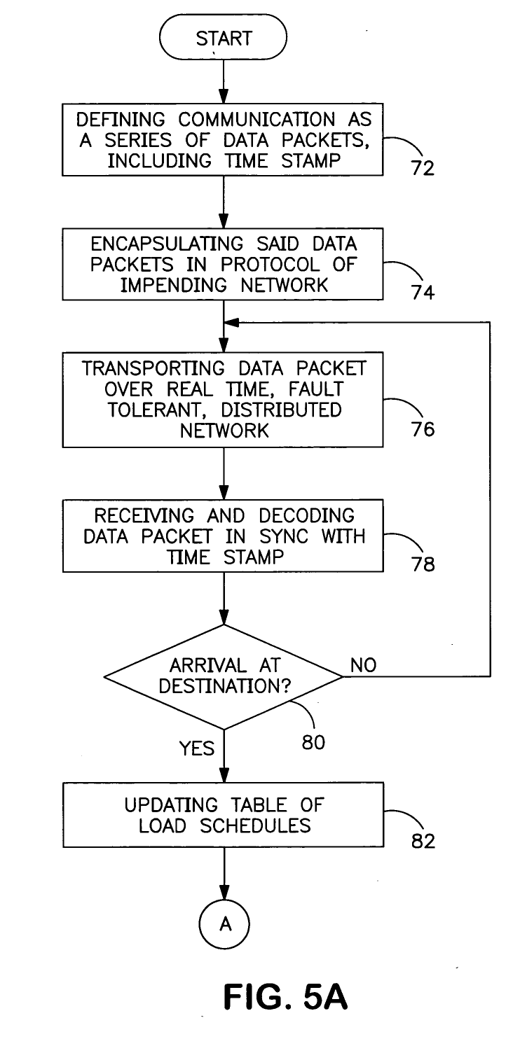

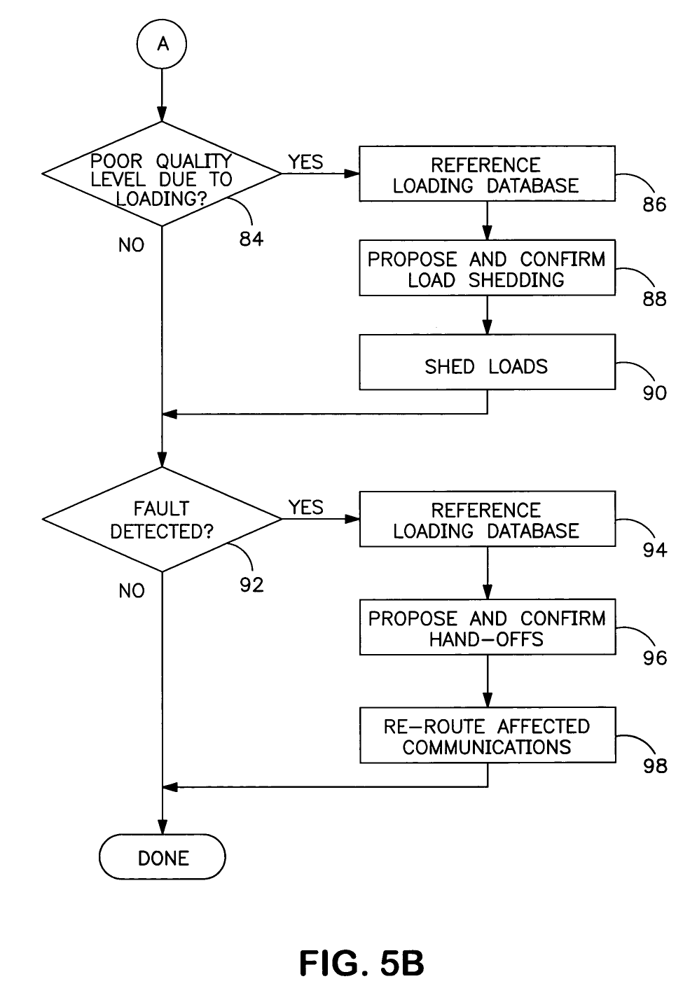

FIGS. 5A and 5B present a flow chart of the preferred method of communication over a telecommunications system in a manner of the invention.

The method begins at step 72 of FIG. 5A by defining a communication as a series of Internet Protocol data packets each of which includes a time stamp for synchronization purposes. As will be described in greater detail hereinafter, the Internet Protocol data packets will be encapsulated into other protocols necessary to carry them over networks with other protocols. In fact, almost any protocol which carries data could be chosen as the basic protocol.

A time stamp is prepared and included with each data packet and will be used to synchronize the timing of the data packets as they arrive at the destination. Synchronisation is important, particularly in the use of connectionless protocols such as the IP. As each packet travels independently, they may not arrive at their destination in the same order, and almost certainly not with the same intervals as they originated. The called party therefore uses the time stamps to ensure proper order of the data packets and their spacings.

The time stamping may be done in a number of manners which may be grouped generally into local or system clocking. Local clocking would include, for example, making reference to global positioning system (GPS) data, national clock broadcast, or to Internet clocking services which are generally available worldwide.

System clocks would include those used for synchronization of ATM and T1 services. For example, ATM networks are generally provided with a 8 kHz sync broadcast capability which is universally accessible and was originally provided for ATM to synchronize constant bit rate transmissions (CBR). ATM clocks running at 192 kHz are also available on some networks.

If the input data is audio, video or voice, this data may be digitized and streamed as known in the art to create data packets continuously from the incoming signal.

Alternatively, the sequence number of arriving packets may be used to sort their order rather than time stamps. However, this results in poorer performance as it does not account for timing differences themselves.

At step 74, the Internet Protocol (IP) data packets are then encapsulated into the protocol compatible with the next telecommunications network in the system, preferably by means of a gateway. In networking, a gateway is combination of hardware and software that links two different types of networks, acting as an entrance from one network into another. Gateways between e-mail systems, for example, allow users on different e-mail systems to exchange messages.

In the preferred embodiment of the invention, all communications will be in IP, encapsulated as necessary to traverse networks having other protocols. Gateways between different networks will therefore strip the encapsulation for the packet arriving and replace it with the encapsulation necessary to traverse the next network.

At step 76, the encapsulated data packets are then transported over the real-time, fault tolerant, distributed telecommunications network by identifying and executing operating system software functions in real-time.

Implementation of a real-time and distributed operating system has been generally described above. However, it is also desirable that the operating system and resulting network also function with much greater reliability than many networks, and in particular, the Internet, has in the past. The public has high expectations for reliability in a telecommunications system, but an Internet system contains a large number of components prone to failure. The system should therefore be fault tolerant, in the sense that failure of individual nodes or links within it does not cause failure of the entire system.

It is desirable that connections, whether for telephony, data, or new applications, survive the failure of the individual computers and links that implement them. This can be implemented automatically by having the system reroute links on failure, as is done now for telephony and Internet connections or by having the various proxies that originally built the connection rebuild it on failure. If the nodes on which the proxies themselves are running fail, they should be reinstantiated on functioning nodes. Techniques known in the art of database technology can be used to ensure that the proxies are able to recover enough of their state to be able to continue, for example, by storing program state on redundant nodes at programmer-defined checkpoints.

At step 78, the data packet is then received at its destination and is decoded. This step will include, of course, removing extraneous headers or encapsulation protocol data, to obtain the signal data from the packet. This data must then be synchronized and coordinated with other received data packets in accordance with the time stamp. As described above, the time stamp and synchronization may be performed in a number of manners.

At step 80, the determination is made as to whether the data packet has arrived at its destination. If not, control returns to repeat steps 76 and 78 until the network or networks have been traversed by the data packet.

At step 82, the components in the network then update, in real-time, their respective tables of load schedules for nodes and paths in the network. This is done so that each component has the necessary data to manage the system load balancing and fault tolerance, which are described hereinafter with respect to steps 84 through 98 of FIG. 5B. This updating is shown as a finite step in a sequence, but is expected that it will be updated periodically, or even in real-time.

A valuable function of distributed operating systems is load balancing: the system assigns new tasks to lightly loaded processors and moves tasks around (dynamic load balancing) as loads change with time. In general-purpose computing the physical location of files is also considered when balancing computing loads so that network traffic does not become a bottleneck. For a telecom system these optimizations are also desirable, and it is preferred that the optimizations be extended to balance use of critical data transmission links. In a telecom access network that uses radio links and that permits double or multiple illumination of customer premises equipment, the choice of which of the two or several radio links to prefer should also be optimized as part of load balancing. Load balancing can be implemented by optimization methods known in the field of operations research.

Balancing loads in computing and telecommunications systems requires estimates of the loads of particular applications. In a general computing environment these loads are usually estimated statistically from recent behaviour of the application, but in a telecommunications environment it is often possible to estimate the computing and data transmission loads a priori: in telephony, for example, the signal processing operations in voice coding and the resulting data rates are precisely known. It is desirable to use this information where available so as to improve the quality of load balancing and to be able to guarantee that overloads will not occur. For this reason it is desirable when using a distributed operating system to operate an access network that the individual filters be characterized as to their computing load and data bandwidth requirements.

In the preferred embodiment of the invention, it is intended that access to resources of the network be negotiated in the manner described in the co-pending patent application under the Patent Cooperation Treaty, Ser. No. _______, titled “Method and System for Negotiating Telecommunication Resources”.

Therefore, at step 84 of FIG. 5B, the system determines whether excessive loading has caused data quality to fall to an unacceptable level. It is preferred that this analysis be made at the device closest to the receiving party that has the capability of making that determination. If for example, the receiving device is a personal computer with a telephony card, it may make this determination. However, if the receiving device is a simple telephone, it may not.

If it is determined that the quality is unacceptable, the system will make reference to the resource loading database at step 86, so that hand-offs may be proposed and confirmed at step 88. This shedding of loads may then be effected at step 90, re-routing the communications that are bogging down the network.

In the preferred embodiment, the shedding of loads is managed by implementing a leaky bucket load shaping model. Leaky buckets are used both in ATM and RSVP to specify average bandwidth. Traffic is modelled in terms of the average output rate and the size of the input buffer needed to smooth bursts out to that rate. A long burst will overflow the bucket, and packets that overflow the bucket are typically marked as candidates for deletion if the network overloads. For a radio link one might interpret these parameters literally, allocating enough radio slots/channels to handle the rate, and putting a buffer at the sending side. For an optical link it may be interpreted only as a specification that defines which packets may be marked for sacrifice.

A variant mechanism is a “token bucket” that allows bursts at full speed until the flow has used up a bucket full of tokens, then restricts flow, rate to the required average as tokens dribble in. These mechanisms directly express queueing behaviour, which is fundamental to networking and may be advantageously applied in implementing the invention.

The choice of what to do with overflow packets is typically fixed in present systems, with packets marked as candidates for deletion, but the system of the invention is flexible enough to allow a wide variety of policies, such as backpressure mechanisms, to be defined.

For coded voice, the average data rate is about 50% of the peak (this is also called the voice activity factor), but users would want to allocate enough bandwidth for the peak so that monologues don't get delayed in a buffer. The radio system still benefits from low voice activity, though, because interference is reduced. A model for 8 kb/s coded voice might be a token bucket (don't delay data) with an input rate of 8 kb/s, refilled with tokens at 5 kb/s (a little margin over 50% utilization) and tens of seconds deep (so that it doesn't empty for 99% of speech bursts). The decision of how to handle data overruns depends on to desired voice quality and whether there is competing traffic, for example the price could go up, a lower-rate coder could be substituted, or a greater FER accepted.

The leaky bucket model doesn't provide all the information that heeds to be known in setting up a path: in a packet-switching system there are generally internal queues whose length is a function of aggregate traffic, and the interaction of the sources is significant. One may need to develop a more informative model, but it will have to degenerate easily to the leaky bucket, because that is what both ATM and RSVP use. One example would be to use a collection of buckets to describe average rates when measured at a variety of queue sizes; a generalization would be some mathematical function describing the relation between queue length and expected rate; and yet more general would be a set of functions relating queue length to a collection of rate statistics (mean and variance, or a collection of percentiles). One should not expect typical developers to be able to figure these things out, but a skilled technician in the art could develop and provide the necessary profiling tools to apply them.

A system and method for negotiating systems resources is described in the co-pending patent application under the Patent Cooperation Treaty, Ser. No. _______, titled “Method and System for Negotiating Telecommunication Resources”.

Returning now to FIG. 5B, the routine for fault detection is presented by means of steps 92 through 98. This routine begins at step 92 with the detection of a fault.

When a fault is detected, reference is made to the resource loading database at step 94, so that hand-offs may be proposed and confirmed at step 96. As noted above, the resource loading database is updated in real-time with the negotiation of new communications, and completion of others. In the preferred embodiment, confirmation will be made with resource managers, agents who administer the loading of the network. These hand-offs may then be effected at step 98, re-routing the effected communications through acceptable nodes and links.

As in the case of step 84, fault detection 92 may be performed in a periodic manner, or continuously in real-time. It is preferred that continuous monitoring be provided by periodic transfers through the network.

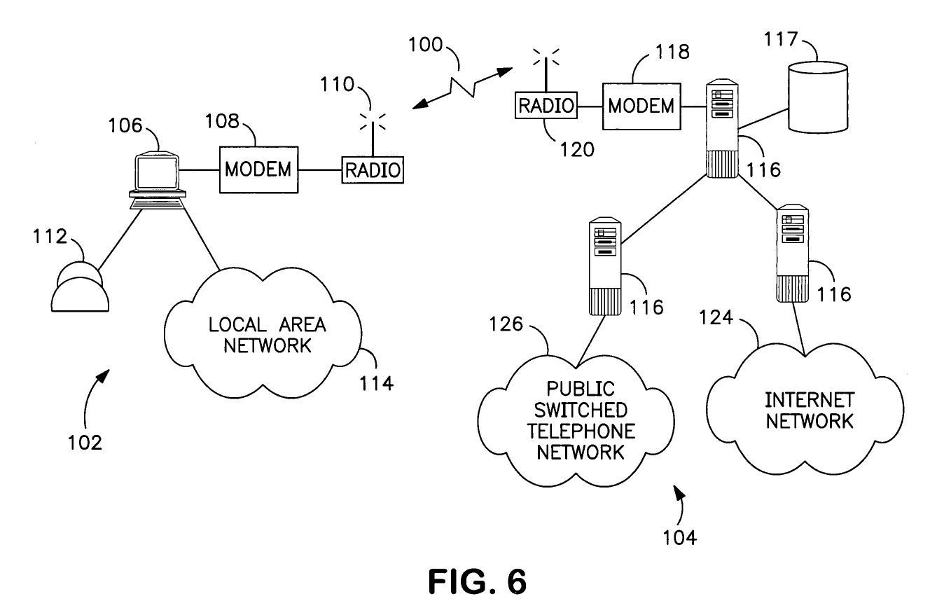

Other features of the preferred embodiment will now be described with respect to the physical schematic presented in FIG. 6. In this embodiment of the invention, there are two types of subsystems connected by a wireless data link 100, which preferably uses third generation (“3 G”) CDMA technology as described by one of the radio transmission technologies proposed to the International Telecommunications Union (ITU). One of these types of subsystems is on the premises of an end user, hereafter called NetPorts 102, the other type, hereafter referred to as NPMs (for NetPort Managers) 104 is mounted on telephone poles or on buildings and is owned by a network service provider such as a telephone company. A single distributed operating system, known as NetOS, runs across this collection of equipment as described below.

In the preferred embodiment of the invention, a NetPort 102 contains a simple computer 106 including one or more central processing unit or units and memory, a modem 118, radio circuitry and antenna 120 necessary to implement the 3 G link, and other components such as a power supply and user interface. The NetPort 102 will also contain the circuitry necessary to connect the computer 106 to a conventional telephone 100 through an RJ-11 connector and circuitry necessary to connect the computer 106 to an Ethernet local area network (LAN) 114 through an RJ-45 connector.

An NPM 104 in the preferred embodiment contains: a high performance computer system including one or more several central processing units 116 and memory 117, a modem 118 and radio circuitry and antennas 120 necessary to implement the 3 G link and other components such as a power supply, user interface, and nonvolatile storage such as disk drives. An NPM 104 will also have circuitry necessary to connect the computer system to a backbone network or networks such as the Internet 124 or the public switched telephone network (PSTN) 126.

Both in the NetPorts 102 and the NPMs 104, the memories preferably include both dynamic memory (DRAM) and persistent storage such as ROM, EEPROM or flash memory. The persistent memory is used to “boot” the computers, providing an initial simple-program permitting them to load the remaining software from disk storage or over their links to other computers.

After booting, both NetPorts 102 and NPMs 104 run an operating system kernel such as real-time Linux or VxWorks, which starts and stops system and application processes and controls their access to such resources as computer memory and the interfaces to input/output devices. Certain of the system processes are given special privileges, such that their requests for resources will be respected, while others are not. System processes may be described as daemons, filter runtime environments (FREs), Java Virtual Machines (JVMs), or servers as described below. Applications processes may be described as filters or agents as described below.

One desirable type of daemon is an “authentication daemon”, which other programs use to verify that information purporting to come from another NetPort 102 or NPM 104 in the system does in fact come from there, or that another NetPort 102 or NPM 104 is in fact running the software that it ought to.

A second desirable type of daemon is a “remoteExec” daemon which can be used by one NPM 104 or NetPort 102 to cause another NPM 104 or NetPort 102 to start a process on another. It does this, after verifying with the authentication daemon that such a request is legitimate and after checking with a database that the requesting process has the appropriate privleges, by using the kernel to cause a new process to begin execution with access to the remotely requested resources.

Most modern operating systems, such as Unix, contain a number of features useful in controlling a distributed operating system, such as commands to “kill” a process, to perform housekeeping tasks at stated times, to list processes currently running, and to list and search disk files. All of these can be remotely invoked, and so can be used by any processor to control another.

Protection mechanisms, which ensure that the control commands described above are not misused, intentionally or otherwise, are required for any robust distributed system and are of importance for the application of distributed computing to a telecommunications access network for two reasons: the communications links and even component computers of the distributed system are inherently exposed to malicious users; and a large system with high user expectations for reliability must be designed to be robust. In the preferred embodiment cryptographic protocols and signatures are used for all operating system control messages over exposed links, and extensive checking is done of the legitimacy of a request.

A standardized protocol for communication among the processors, such as an IP stack running over Ethernet or ATM, permits software to be written in a consistent manner. Similarly, a consistent standard for reporting performance or failure, such as Simple Network Management Protocol (SNMP) simplifies the software required for system maintenance. SNMP is the most widely-used network management protocol on TCP/IP based networks.

The value of the system is considerably increased if the streams of data representing particular connections, for example the data streams that encode voice, can be passed through “filters”. For telephony, filters may be defined, inter alia, to:
I. compress the stream so as to reduce required bandwidth;
II. encrypt the voice signal, so that interception is made difficult;
III. store the signal on disk, or convert it to an e-mail attachment, for voice mail;
IV. apply tone controls, such as bass boost, to the signal to improve the subjective quality of the call;
V. combine multiple streams into one, for voice conferencing;
VI. combine multiple streams for rate matching in a CDMA-communications system;
VII. monitor a stream for TouchTone dialing;
VIII. monitor a stream for voice commands,
IX. authenticate a person's identity by comparing his voice pattern to a stored template; or
X. acquire the voice stream from, or play it to, the physical coders and decoders connected to a telephone.

A particular type of process which may be started on a NetPort 102 or NPM 104 is known as a Filter Runtime Environment (FRE). This is a process which can be used to run a collection of filters, which are described above. In one embodiment the filters are implemented as subroutines that are interconnected dynamically to allow an FRE to have a behaviour defined flexibly by the particular interconnection of filters that compose it: for example to apply tone controls, compress voice, then encrypt it for transmission and store a copy of the encrypted voice on voice-mail, and to cryptographically sign the resulting voice-mail as having originated from the claimed caller.

A collection of proxies and protocols as described below is used to implement a “call processing” or “connection management” layer of software. This software is responsible for negotiating and defining the collections of filters that will implement the actual telephone calls, data connections, or other telecommunications services.

Proxy or “agent” software represents the requirements of individual users and of terminals (such as telephones), a proxy for an end-user might constrain the time of day at which calls will be accepted, while a proxy for a telephone in a public area might not permit long-distance calls to be placed. Similarly, for an IP data stream a proxy for a computer in a school might filter out pornographic content.

Since it is desirable that a large number of developers should be able to write these proxies, it is also desirable that the security of the overall system cannot be compromised by them. This can be arranged by requiring that proxies run in a secure “sandbox” such as provided by Java. The “sandbox” approach to security is one in which an applet is only allowed to operate within certain-bounds (the sandbox). This constrained runtime environment prevents applets from accessing and altering unauthorized areas, or performing otherwise harmful operations, such as reading or writing files to the Client's hard disk or establishing network connections except to the server that the applet came from.

Proxy software is also desirable to represent the interests of the network operator, who must ration such resources as licensed spectrum and backhaul capacity, and perhaps the constraints imposed by the operator's service level agreements with backbone operators. This software could be implemented in Java, but could also be implemented as a distributed database application in C++ which is preferred because these proxies may be required to operate at high speeds while managing large networks with complex constraints.

Standard protocols for negotiation among the various proxies permit interoperability. In a simple embodiment, it is taken as a starting point that all parties to a negotiation agree on a given minimum or standard-type of connection (such as a caller-paid connection to a message or terminal of the called party's choosing, using PCM voice coding); the various parties are then permitted to exchange offers for connections that they consider more desirable in the hope of finding one that is more desirable to all parties.

Accounting mechanisms are desirable for large systems, although they are sometimes dispensed with in smaller networks serving a single organization. They can be implemented by having the network proxy maintain records of telephone and data traffic for later billing or by including payment negotiation in the act of setting up a connection.

Applications programming interface (APIs), implemented as libraries of Java or C++ methods, can be used to describe desired connectivity: for example with methods that request connection to a particular telephone number or IP address, or that give a website address (URL) or name of a company or service. They can also describe desired quality of connection: for example in terms of desired subjective quality (Mean Opinion Score) or bandwidth, failure rate and latency. Part of the API for describing connections can include a mechanism for responding to failures, such as a set of exceptions.

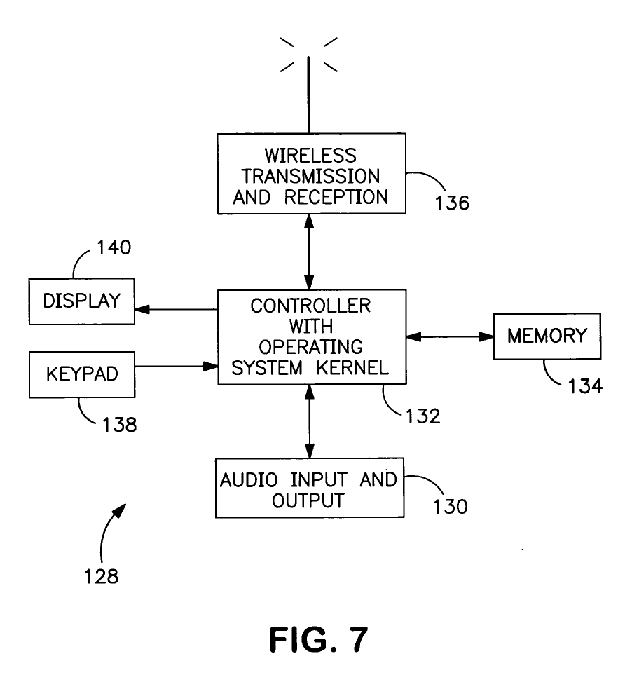

The power of the invention is also clear from its application to a cellular telephone. FIG. 7 presents a electrical block diagram of a cellular telephone 128 in a manner of the invention. Rather than a device with a predetermined and fixed function, this cellular telephone 128 has far greater capability and flexibility than existing devices, and may be updated as necessary or even continuously.

This cellular telephone 128 consists of standard components such as the audio input and output 130, which would include analogue to digital and digital to analogue converters to pass voice signals to and from the central controller 132. This central controller 132 may, for example, be a digital signal processor, microprocessor or microcontroller.

Current microprocessors with MMX™ technology could be modified for the purposes of the invention. MMX™ is a Pentium™ microprocessor from Intel™ that is designed to run faster when playing multimedia applications. According to Intel™, a PC with an MMX™ microprocessor runs a multimedia application up to 60% faster than one with a microprocessor having the same clock speed but without MMX™. In addition, an MMX™ microprocessor runs other applications about 10% faster.

The MMX™ technology consists of three improvements over the non-MMX™ Pentium™ microprocessor.
1. 57 new microprocessor instructions have been added that are designed to handle video, audio, and graphical data more efficiently;
2. a new process, Single Instruction Multiple Data (SIMD), makes it possible for one instruction to perform the same operation on multiple data items; and
3. the memory cache on the microprocessor which has increased to 32 thousand bytes, meaning fewer accesses to memory that is off the microprocessor.

Such microprocessors are a common commercial component and have correspondingly low prices and broadly available applications software.

The microprocessor preferably stores the operating system kernel in an internal memory cache though this memory 134 may be off-processor as shown in FIG. 7. This off-processor memory 134 is preferably a non-volatile memory such as an electrically erasable programmable read only memory (EEPROM) or FlashROM, but, may also be a volatile memory such as a random access memory (RAM). This memory 134 may be used to store the desired digitization, encryption and protocol algorithms, which are downloaded via the wireless input/output. Because the operating system is distributed, it is not necessary to store much functionality in the cellular telephone 128, but is preferable to store functions common required because of the resulting increases in processing speed.

This cellular telephone 128 also includes a standard telephone keypad 138 and display 140, however, more advanced components could also be used. For example, rather than a liquid crystal display (LCD) with a single line of alpha numeric characters, the display 140 could comprise an LCD pixel matrix which could display graphics as well as alphanumerics. Rather than a traditional telephone keypad 138, the keypad 138 could comprise a mouse and pushbutton which drives a cursor on the display 140 and selects icons in a graphic user interface (GUI) to execute desired functions.

Other arrangements would also be clear to one skilled in the art from the teachings herein. The invention allows the cellular telephony or similar telephony device to be upgraded by downloading the latest software or new software functions that are desired. Existing cellular telephones have fixed functionality and become obsolete when the networks are upgraded.

Similarly, a modem connected to a personal computer could be programmable in the same manner. Of course, a comparable arrangement could be made to any telephony device, be it a personal digital assistant, fax machine, pager, point of sale computer, local area networks or private branch exchanges. While particular embodiments of the present invention have been shown and described, it is clear that changes and modifications may be made to such embodiments without departing from the true scope and spirit of the invention.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

It would also be clear to one skilled in the art that this invention need not be limited to the described scope of computers and computer systems. Credit, debit, bank and smart cards could be encoded to apply the invention to their respective applications. Again, such implementations would be clear to one skilled in the art, and do not take away from the invention.

1. A method of implementing a communication over a telecommunications network comprising the steps of:
defining said communication as a stream of data; and
transporting said stream of data over said telecommunications network by identifying and executing operating system software functions in real-time, where said operating system software functions are distributed over said telecommunications network.

2. A method as claimed in claim 1, wherein said steps of defining and transporting comprise the steps of:
defining said communication as a series of Internet Protocol data packets;
encapsulating said Internet Protocol data packets in a second protocol compatible with said telecommunications network; and
transporting said encapsulated data packets over said telecommunications network by identifying and executing operating system software functions in real-time, where said operating system software functions are distributed over said telecommunications network.

3. A method as claimed in claim 1, wherein said step of transporting comprise the step of:
transporting said encapsulated data packets over said telecommunications network by identifying and executing filters in real-time, where said filters are distributed over said telecommunications network.

4. A method as claimed in claim 2 comprising the subsequent step of:
receiving and decoding said transported Internet Protocol data packets in real-time synchronisation with the defining of said Internet Protocol data packets; and
said step of defining comprising the step of:
defining said communication as a series of Internet Protocol data packets, where said communication is a digitized audio communication.

5. A method as claimed in claim 4 wherein:
said step of defining comprises the step of:
defining said communication as a series of Internet Protocol data packets, and including a time stamp, where said communication is a digitized audio communication; and
said step of receiving and decoding comprises the step of:
receiving and decoding said transported Internet Protocol data packets in real-time synchronisation with the defining of said Internet Protocol data packets by reference to said time stamp.

6. A method as claimed in claim 4, wherein
said step of defining comprises the step of:
defining said communication as a series of Internet Protocol data packets, and including a Global Positioning System (GPS) time stamp, where said communication is a digitized audio communication; and
said step of receiving and decoding comprises the step of:
receiving and decoding said transported Internet Protocol data packets in real-time synchronisation with the defining of said Internet Protocol data packets by reference to said GPS time stamp.

7. A method as claimed in claim 2, further comprising the steps of:
monitoring quality of service for said communication; and
responding to an unacceptable level of quality of service by shedding communications being handled by said telecommunications network.

8. A method as claimed in claim 7, wherein said telecommunications network includes nodes and paths, wherein:
said step of monitoring comprises the step of:
monitoring quality of service for each of said nodes and paths for said communication; and
said step of responding comprises the step of:
responding to an unacceptable level of quality of service by shedding loads imposed on corresponding ones of said nodes or paths.

9. A method as claimed in claim 8, wherein said step of monitoring comprises the step of:
updating in real-time, a table of load schedules for said nodes and paths.

10. A method as claimed in claim 9, further comprising the step of:
negotiating and planning load schedules for said nodes and paths.

11. A method as claimed in claim 2, wherein said step of defining comprises the step of:
defining said communication as a series of Internet Protocol data packets, said data being digitally encrypted.

12. A method as claimed in claim 2, wherein said step of transporting comprises the step of:
transporting said encapsulated data packets over said telecommunications network by identifying and executing operating system software functions in real-time, where said operating system software functions are fault-tolerant and distributed over said telecommunications network.

13. A method as claimed in claim 12, further comprising the step of:
responding to a fault by rerouting calls.

14. A method as claimed in claim 13, wherein said step of responding comprises the step of:
responding to a fault by:
referencing a real-time resource loading database;
proposing new hand-offs and confirming with respective resource managers; and
re-routing affected communications accordingly.

15. A telecommunications system comprising:
a calling party;
a called party;
a mixed-protocol telecommunications network-interconnecting said calling party and said called party;
said calling party being operable to:
define said communication as a data packet; and
said telecommunications network being operable to:
transport said data packet to said called party by identifying and executing operating system software functions in real-time, where said operating system software functions are distributed over said telecommunications network.

16. A cellular telephone comprising:
central processor means;
wireless communication input and output means connected to said central processor means;
memory storage means connected to said central processor for storing software code downloaded via said wireless communication input and output means, said software code being executable on said central processor;
real-time distributed operating system kernel software code executable on said central processor; and
user interface means interconnected with said central processor.

17. A cellular telephone as claimed in claim 16 wherein said memory storage means comprises electrically erasable programmable read only memory.

18. A cellular telephone as claimed in claim 17 wherein said real-time distributed operating system kernel software code is stored in a memory cache of said central processing means.

19. A cellular telephone as claimed in claim 18 wherein said user interface comprises a microphone and speaker.

20. A cellular telephone as claimed in claim 19 wherein said user interface further comprises a graphic user interface and mouse.

21. A computer readable memory medium, storing computer software code executable to perform the steps of:
defining said communication as a data packet; and
transporting said data packet over said telecommunications network by identifying and executing operating system software functions in real-time, where said operating system software functions are distributed over said telecommunications network.

22. A computer data signal embodied in a carrier wave, said computer data signal comprising a set of machine executable code being executable by a computer to perform the steps of:
defining said communication as a data packet; and
transporting said data packet over said telecommunications network by identifying and executing operating system software functions in real-time, where said operating system software functions are distributed over said telecommunications network.
